(19) United States
(12) Patent Application Publication
(10) Pub. No.: US 2014/0059131 A1
(43) Pub. Date: Feb. 27, 2014

(54) METHOD AND SYSTEM FOR REGULATING MEDIATED ANONYMOUS COMMUNICATION

(71) Applicant: "DUVAMIS" EOOD, Sofia (BG)

(72) Inventor: Dobromir Hristov GOUSHTEROV, Sofia (BG)

(73) Assignee: ''DUVAMIS'' EOOD, Sofia (BG)

(21) Appl. No.: 13/897,443

(22) Filed: May 20, 2013

(30) Foreign Application Priority Data
Aug. 22, 2012 (BG) 111295

(51) Int. Cl. H04L 29/06

(52) U.S. Cl. CPC H04L 65/40
USPC 709/204

(57) ABSTRACT

The invention refers to a method and system for regulating mediated anonymous communication to be applied to the communication between network users. According to this method the users (1) via user devices (2) connect to the network environment (3) and receive an opportunity to register and use the services of the provider (4). Then the users (1) create their own user account (5) allowing them to create an unlimited number of virtual visions (8). Each virtual vision (8) has an own name and differentiating characteristics, including time characteristics, as assigned by the creator (1). Each virtual vision (8) of any creator (1) can be used for mediated contacts with the other virtual visions (8), as well as mediated contacts with the virtual visions (8) of its creator (1) or owner. Each virtual vision (8) is objectified for the other network participants at a moment in time predetermined by its creator or upon the occurrence of circumstances as predefined by the creator.

### CROSS-REFERENCE TO RELATED APPLICATIONS

This application claims priority to, and the benefit of, under 35 U.S.C. 119, Bulgarian Patent Application No. 111295, filed on Aug. 22, 2012, the disclosure of which is incorporated herein in its entirety.

### TECHNICAL FIELD

The invention refers to a method and system for regulating mediated anonymous communication to be applied mainly but not only to the communication between network users.

### BACKGROUND OF THE INVENTION

It is known that in some of the interactive games in order to objectify themselves in the game the participants have to chose from a limited number and type of predetermined visions possessing specific features and characteristics. The visions are created by those providing the interactive game service. Such visions may be specific mythical heroes, different races of people or aliens and/or objects, or various types of devices and machines.

A disadvantage of the user profiles used in the interactive games is the inability of the user to create their own character due to the restrictions relating to the choice of available characters. For instance, a choice is offered of a certain number of mythical heroes or people, types of machines, etc. as well as the specificity of services provided does not allow for full-fledged communication between the human individuals.

It is also known that online communication using the existing social networks and media, email or other channels is carried out via the so called unique profiles which as regulated by the service providers aim at recreating specific social characteristics of the user and thus reveal his/her identity in a social environment. Thus each social network user is required to register by entering social data such as name, gender, age, education, etc.

A disadvantage of the existing online communication systems and methods is that the user can only have one profile where it is advisable to enter social data and in some cases it is even required to do so hence user anonymity is lost.

### SUMMARY OF THE INVENTION

A goal of to develop a method and a system for regulating mediated anonymous communication in computer mediated environment by using a large number of different virtual visions created that reflect a specific idea of the creator and not his/her social, biological characteristics but rather constituting free mental projections.

This goal is achieved by designing a method for regulating the mediated anonymous communication wherein the following sequence of operations take place:

The users via user or IT communication devices such as mobile phones, tablets, PCs connect to the computer environment network, for instance Internet;

Upon registration the users create their own account; and

Acquire rights to use the functionalities offered by the service provider.

According to the invention:

then the users create one or more virtual visions associated with the user account with each user becoming a creator by virtue of creating at least one virtual vision;

each virtual vision has its own name and differentiating features, including time features, as assigned by its creator; and

via each virtual vision of any creator contacts with other visions as well as the other visions of the same creator can be mediated using the specific services offered by the provider.

The virtual link between the creator and his/her virtual visions remains invisible for the other creators using the provider's services.

The characteristics of each virtual vision are developed as a projection of their creator and depict each creator's idea without limitation to known material, biological and other objects, subjects or social identities.

Another specificity of this invention is that each virtual vision is objectified for the other participants in the network at a moment in time selected by the creator or upon the occurrence of concrete circumstances as predetermined by the creator.

The creator, respectively the owner of a given virtual vision, may operate freely with it and is able to change its differentiating characteristics, including to delete it from the system.

The creator, respectively the owner of a given virtual vision, for instance may leave it as memory to the other participants thus indicating its inactivity, but the creator has the functional option of reactivating it at any time.

Also, the creator, respectively the owner of a given virtual vision, may bequeath it, transfer it and sell it to other creators thus severing the connection between the given virtual vision and its previous owner or creator.

The system for regulating the mediated (anonymous) communication, positioned in a computer network environment, mainly Internet, whose users employ it via user devices upon registrations, is characterized with each creator owning at least one virtual vision created by them and having certain differentiating characteristics which visions communicate using the provider's services. The functional link between the creator and his/her virtual visions is not visible to the other creators, respectively owners of virtual visions using the provider's services.

The advantage of the invention lies in devising a method regulating anonymous communication mediated via virtual visions created as projections of the creators and allowing for computer-mediated communication on different online communication platforms. The functional link between the creator and his/her virtual visions is not visible to the other members using the provider's services.

Another advantage of this invention is that it allows for the virtual visions created by the user to be objectified in the network upon the occurrence of a time or circumstances determined by the creator which reinforces the pre-regulated mediated anonymity that the invention strives to achieve.

### BRIEF DESCRIPTION OF THE DRAWINGS

FIG. 1 shows a block scheme of the system for regulating the mediated (anonymous) communication in a network environment.

FIG. 2 shows a block scheme of communication between creators via their virtual visions.

### DETAILED DESCRIPTION OF THE INVENTION

The method of regulating the mediated (anonymous) communication involves the following sequence of operations:

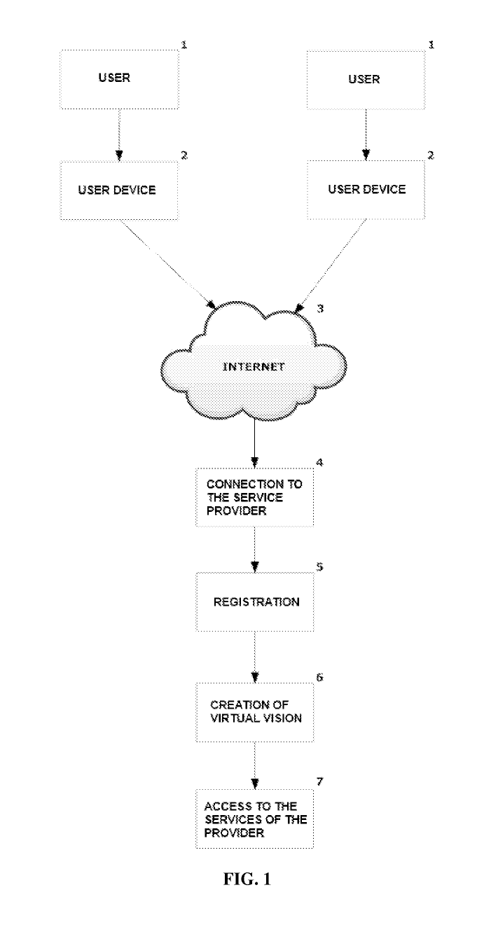

The users 1 via user devices 2 (e.g. Mobile devices, tablets, PCs, etc.) connect to the network environment 3 (e.g. Internet)—FIG. 1. Upon connecting to the computer network environment 3, the users 1 have complied with one of the conditions for accessing the provider 4 services by logging into the system 5 of the provider 4. The provider 4 provides the services through a system (communication platform) put on a number of servers that are appropriately connected to the computer network environment 3. In order to use the services of the provider 4 however each user 1 is required to create their own user account on the provider's servers by registering 5. Following the set up of an own user account each user 1 can create 6 one or more virtual visions and thus the users acquire access to the services 7 of the provider 4.

Following the creation of at least one virtual vision 6 each user becomes a creator in the provider's system.

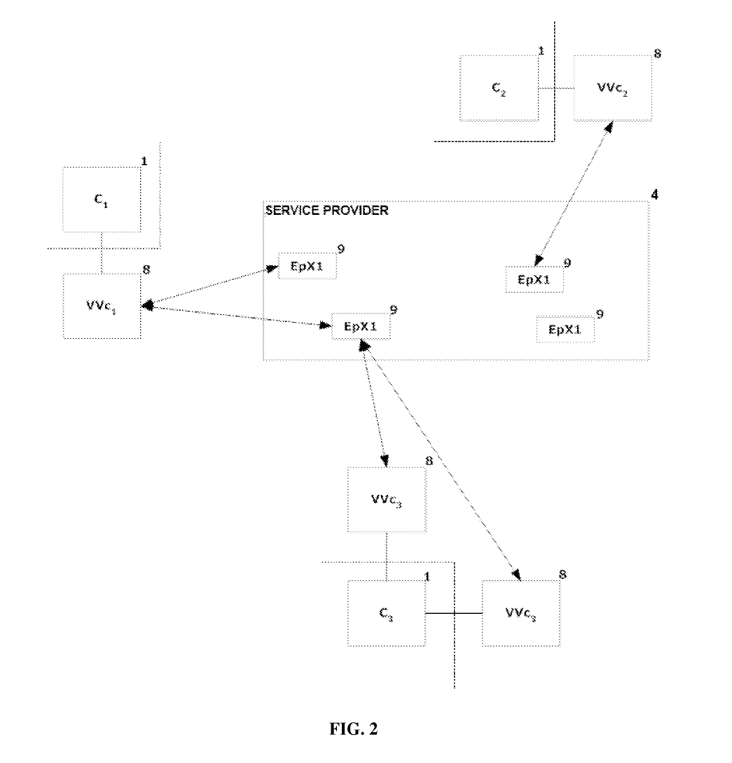

The account created by way of registration 5 allows each user 1 to create an unlimited number of virtual visions 8—FIG. 2 with their own names and unique differentiating features as desired by their creator 1.

Each virtual vision 8 is a specific entry in the data base of the service provider 4 as formed by the specific technical requirements of the provider.

For instance:

VIRTUAL VISION 1 (VV1)—whose name is Aurora X Project and whose differentiating characteristics are—“avatar type profile photograph”—“space shuttle”, “casing—plasma aerodynamic shield”, “cargo section—2 tons of research equipment”;

VIRTUAL VISION 2 (VV2)—whose name is “Song of Love” and whose differentiating characteristics are—“love melody”, “slow and melodic tempo”, “unknown author”, “multimedia feature—the audio of the song”; and

VIRTUAL VISION 3 (VV3)—“Covert” whose creator has not entered any other differentiating characteristics but the name “Covert”.

The examples above refer to virtual visions 8 with audio, visual and text characteristics but they do not exhaust all the options that the provider 4 system offers for the creation and characterization of virtual visions 8—FIG. 2.

The communication between the creators 1 in the network environment 3 takes place, but is not limited to, in a mediated manner via the created and/or acquired virtual visions 8 thus ensuring social and biological anonymity in using the services 7—FIG. 1 of the provider 4. The communication between the visions is carried out via certain communication functionalities 9 (EpX1)—FIG. 2 offered by the service providers 4. Using an unlimited number of created and/or acquired virtual visions 8 the creator 1 can use the services of the provider 4 by using the functionalities on behalf of the virtual vision 8 selected by them at a given moment.

The communication between the virtual visions 8 is free and can take many aspects. For example:

VVc1 (virtual vision 1) of C1 (creator 1) may communicate freely with VVc2 (virtual vision) of C2 (creator 2)—one virtual vision 8 communicates with only one other virtual vision 8 of another creator C.

VVc1 and VVc2 of C1 communicate as if they belong to different creators with VV3 of C2.

VVc 1 of C1 establishes contact with VVc2 of C2 and with VVc3 of C3 (creator 3) entering into dialog.

This invention does not allow for communication between virtual visions and social persons (profile of the social person).

The functional link between the creator 1 and his/her virtual visions 8 is invisible to the other creators 1 using the services of the provider 4.

Each virtual vision 8 has its own name and differentiating characteristics, including time characteristics, as assigned by its creator 1.

The differences between the virtual vision and the social person lie in the way their characteristics are described. Virtual vision 8 is an individual, intellectual project of its creator 1 and may depict both living creatures, and objects and mental ideas without limitation of the creator 1. Unlike the social vision the social profile corresponds to a specific person with their social and biological characteristics such as name, age, hair color, weight, height, and all other social attributes—education, date of birth, place of birth, social status, social contacts, etc, including personal data.

The service provider 4 does not impose any restrictions on the creators 1 as to the virtual visions 8 they create, whose differentiating characteristics by regulated definition should not be fully or partially identified with the social characteristics of the creator 1 or any other member of the community.

The creator 1 of a virtual vision 8 is free to operate it and change its differentiating characteristics (name excluded), to delete it, to revive it, to leave it as memory, as well as to indirectly bequeath, transfer, and sell it to other creators 1 registered with the service provider 4 via their virtual visions 8.

The right-holder of a virtual vision 8, e.g. upon purchasing or inheriting it, is equally free to operate the acquired virtual vision 8. In this process though the link between the virtual vision 8 and its creator 1 or its previous owner is severed.

The system of the service provider 4 allows for postponed visualization of content posted for the other virtual visions 8 as well as for postponed objectification of a created virtual vision 8 for the other users 1 of the services of the provider 4. The visualization of deferred content may take place at a specific moment in time or upon the occurrence of other circumstances as predetermined by the creator 1, respectively the owner of the virtual vision 8.

In this way for instance a given piece of information may be visualized for the other creators 1 of the provider's 4 services upon certain circumstances such as reaching a given moment in time (year, month, date, time), changing the exchange rate, reaching a certain value of stocks, achieving certain economic or other social indicators, as well as in any other case not specified above.

The proposed system for achieving regulated mediated communication in the communication platforms of the service provider 4 via the creation of an unlimited number of mental projections of the creator 1 allows the creator 1 to conceal his/her social and/or biological characteristics. This serves as a pre-requisite for increased creativity of the users 1 in the online communication environments 3.

1. A method for the regulation of mediated anonymous communication wherein users (1), via user and IT communication devices (2), such as mobile devices, tablets, and PCs, connect to a computer network environment (3), e.g. Internet, upon registration (1), create their own account (5), and acquire rights to use the functionalities of the service provider (4), wherein following registration, the users create one or more virtual visions (8) associated with the user account (5) whereupon by creating at least one virtual vision (8) each user becomes a creator (1) with each virtual vision (8) having its own name and differentiating features, including time characteristics, as assigned by its creator (1) with each virtual vision (8) of any creator (1) allowing for mediated contacts using the specific services provided by the provider (4) with the other visions (8) as well as mediated contact with the other virtual visions (8) of its creator (1) while at the same time the functional link between the creator (1) and its virtual visions (8) remains invisible for the other creators (1), using the services of the provider (4).

2. The method according to claim 1, wherein the characteristics of the virtual vision (8) are created as a projection of its creator (1) and depict the creator's ideas without being restricted to known material, biological and other objects, subjects or social identities.

3. The method according to claim 1, wherein each virtual vision (8) is objectified for the other participants in the network (3) at a moment in time predetermined by its creator (1).

4. The method according to claim 1, wherein each virtual vision (8) is objectified for the other participants in the network (3) upon the occurrence of circumstances predetermined by its creator (1).

5. The method according to claim 1, wherein the creator (1), respectively the owner of the virtual vision (8), may freely operate with it being able to change its differentiating characteristics, including to delete it from the system.

6. The method according to claim 1, wherein the creator (1), respectively the owner of the virtual vision (8), may leave it as memory to the other participants thus indicating its inactivity, but having the functional option of reactivating it at any time.

7. The method according to claim 1, wherein the creator (1), respectively the owner of the virtual vision (8) can bequeath it, transfer it and sell it to other creators (1) whereupon the link between the virtual vision (8) and its creator (1) or former owner is severed.

8. A system for regulating a mediated (anonymous) communication positioned in a computer-network environment (3), mainly Internet, whose users (1) access it via user devices (2) upon registration wherein each creator (1) owns at least one created virtual vision (8) having differentiating characteristics as selected by the creator which virtual visions communicate among themselves using the services of the provider (4), with the functional link between the creator (1) and his/her virtual visions (8) being invisible for the other creators (1), respectively owners of virtual visions (8) using the services of the provider (4).
